(19) United States
(12) Patent Application Publication
(10) Pub. No.: US 2023/0267456 A1
(43) Pub. Date: Aug. 24, 2023

(54) BLOCKCHAIN SYSTEMS AND METHODS

(71) Applicant: LION'S MANE DEVELOPMENT PTY LTD, TOOWOOMBA QLD (AU)

(72) Inventors: Ryan GARNER, TOOWOOMBA QLD (AU); Raymond MOGG, TOOWOOMBA QLD (AU)

(21) Appl. No.: 17/660,337

(22) Filed: Apr. 22, 2022

(30) Foreign Application Priority Data
Feb. 22, 2022 (AU) 2022201218

(51) Int. Cl. G06Q 20/38; G06Q 20/40

(52) U.S. Cl. CPC G06Q 20/3825; G06Q 20/401; G06Q 2220/00

(57) ABSTRACT

A blockchain system and method is provided that enables perpetual financial products to be provided in an efficient manner. The system includes: an oracle feed, defined on a blockchain, the oracle feed representing an off-chain data feed; first and second token pools defined on the blockchain, each token pool including at least one pool token; a smart contract defined by code on the blockchain, the smart contract configured to autonomously transfer pool tokens between the first and second pools according to data of the oracle feed; and first and second contract tokens defined on the blockchain, each contract token associated with the smart contract and the first and second token pools.

### CROSS REFERENCE TO RELATED APPLICATIONS

The present application claims priority under 35 U.S.C. §119 to Australian Patent Application No. AU 2022201218, filed on Feb. 22, 2022, entitled “BLOCKCHAIN SYSTEMS AND METHODS,” the entirety of which is incorporated by reference herein.

### TECHNICAL FIELD

The present invention relates to blockchain systems and methods. In particular, although not exclusively, the present invention relates to blockchain systems and methods for use in relation to financial products, such as financial derivatives.

### BACKGROUND ART

Derivatives are financial instruments that derive their value from an underlying asset. A futures contract is an example of a derivative, that is essentially a financial contract between two parties to sell and buy an asset at a set price in the future. In other words, future contracts allow two parties to agree on the price at which they will exchange an asset in the future.

A perpetual swap is somewhat similar to a futures contract, but does not have an expiry date. Traders can long or short an underlying asset (e.g. Bitcoin) by purchasing long or short perpetual swaps and selling them at some time in the future.

A problem with perpetual swaps of the prior art is that they are inefficient, particularly for leveraged trading, as their liquidation mechanism is costly and inefficient. In particular, when a trader’s unrealized loss comes anywhere near the collateral deposited, exchanges will generally close the trader’s position and take the remaining collateral.

Such systems essentially prevent the use of small amounts of collateral and large leverage, as traders in such case risk being liquidated, even with fairly mild volatility.

Another problem with perpetual swaps (and similar financial products) of the prior art, is that market participation may be blocked, e.g. due to system failure, maintenance or third party intervention, which may prevent users from conducting critical, time-sensitive transactions. This is clearly disadvantageous.

As such, there is clearly a need for improved blockchain systems and methods, including those that alleviate the abovementioned problems.

It will be clearly understood that, if a prior art publication is referred to herein, this reference does not constitute an admission that the publication forms part of the common general knowledge in the art in Australia or in any other country.

### SUMMARY OF INVENTION

The present invention relates to blockchain systems and methods, which may at least partially overcome at least one of the abovementioned disadvantages or provide the consumer with a useful or commercial choice.

With the foregoing in view, the present invention in one form, resides broadly in a blockchain system including:
an oracle feed, defined on a blockchain, the oracle feed representing an off-chain data feed;
first and second token pools defined on the blockchain, each token pool including at least one pool token;
a smart contract defined by code on the blockchain, the smart contract configured to autonomously transfer pool tokens between the first and second pools according to data of the oracle feed; and
first and second contract tokens defined on the blockchain, each contract token associated with the smart contract and the first and second token pools.

Advantageously, the blockchain system enables actions to be performed on the blockchain sustainably and in perpetuity. In particular, the transfer of pool tokens enables the actions to be performed sustainably according to changes in the off-chain data feed.

The system may be used in any context, but is particularly useful in relation to perpetual swaps and perpetual pools, wherein the oracle feed corresponds to a price feed (e.g. a BTC/USDC price feed), the contract tokens correspond to long and short positions relating to the price feed, and the pool tokens comprise collateral (e.g. USDC tokens) that is transferred between the token pools according to changes in the price feed.

Preferably, the oracle feed corresponds to a price feed. The oracle feed may be generated according to an aggregate of price feeds. Preferably, the smart contract corresponds to a financial derivative associated with the price feed(s).

Preferably, the pool tokens comprise ERC20 tokens. The term tokens here refers to any transferable unit, including partial tokens.

Preferably, the system includes one or more smart contract templates defined in the blockchain. Preferably, the smart contract comprises an instance of a smart contract template of the one or more smart contract templates. The one or more smart contract templates may comprise a plurality of smart contract templates.

Preferably, the system includes a decentralized autonomous organization (DAO), represented by rules encoded as code in the blockchain, which govern the ability to add to or modify the plurality of smart contract templates.

Preferably, the smart contract comprises a perpetual swap smart contract. Preferably, the system includes a perpetual swap smart contract template on what the perpetual swap contract is based. The perpetual swap smart contract template may be configured to use a price feed and base asset to define the perpetual swap smart contract.

Preferably, the smart contract is configured to enable the autonomous transfer of contract tokens when a size of the associated pool is below a threshold.

Preferably, the transfer of pool tokens between the first and second pools is according to a transfer function (funding rate) defined by the smart contract and the oracle feed.

Preferably, the transfer function is defined at least in part according to a time-weighted difference between 1) a mark price of the derivative position defined by the contract tokens and 2) an index price provided by the oracle feed adjusted by a time-value component.

The time-value component may comprise a weighted average of the index price over time, where recent index prices have a higher weight than older index prices.

Preferably, the transfer of pool tokens is defined at least in part according to a sensitivity factor, the sensitivity factor defined according to a historical volatility of the oracle feed or a generalisation thereof.

The transfer function may be defined at least in part according to a leverage factor.

Preferably, the autonomous transfer of contract tokens when a size of the associated pool is below a threshold is to avoid or reduce the risk of insufficient tokens to enable the transfer of pool tokens between the first and second pools according to the data of the oracle feed.

Preferably, the threshold comprises a function of a notional value of the corresponding contract token, the leverage, and the cost required to perform a transaction on the blockchain.

In some embodiments, the threshold (Maintenance margin) is defined according to:

$$\begin{matrix}\text{Maintenance margin} = \frac{\text{Notional value}}{\text{Maximum leverage}} + \\ 6 ⋅ \left(\text{Liquidation gas cost}\right)\end{matrix}$$

where the Notional value is the notional value of the corresponding contract token, the Maximum leverage is the leverage used, and the Liquidation gas costs comprises the cost required to perform a transaction on the blockchain.

Preferably, the smart contract is configured to calculate a difference between a value of the transfer of the contract tokens and the subsequent value of a subsequent transfer of the contract tokens, and transfer pool tokens according to a difference between the value and subsequent value when the subsequent transfer of the contract tokens is within a defined period of time from the transfer of the contract tokens. The defined period may comprise a pre-defined period. The pre-defined period may be less than 20 minutes. The predefined period may be about 10 minutes.

Preferably, the smart contract is configured to determine insufficient pool tokens to perform the transfer, transfer all pool tokens, and transfer insurance tokens from an insurance pool, corresponding to a difference between the value of the pool tokens and the difference caused by the change in value.

Preferably, the smart contract is configured to transfer pool tokens to the insurance pool over time.

Preferably, the smart contract enables payment from the insurance pool according to number of tokens in the insurance pool. As such, collateral may be provided to the insurance pool in return for payment that likens interest.

Preferably, the smart contract comprises a perpetual pool smart contract. Preferably, the system includes a perpetual pool smart contract template on what the perpetual pool contract is based. The perpetual pool smart contract template may be configured to use a price feed and base asset to define the perpetual pool smart contract.

Preferably, the first and second token pools each include a plurality of pool tokens.

Preferably, the transfer of pool tokens between the first and second pools is according to a transfer function defined by the smart contract and the oracle feed.

Preferably, the transfer of pool tokens between the first and second pools occurs upon a pre-defined condition being met. Preferably, the pre-defined condition is a predefined time period.

Preferably, the transfer function is non-linear.

Preferably, the transfer function is configured to transfer less than 100% regardless of a change in the oracle feed and leverage used.

Preferably, the transfer function is configured to provide near linear returns for small price movements (according to the leverage), and dampened returns for large price movements.

In one embodiment, the transfer function is defined according to:

$$\text{Value Transfer} \left(\%\right) = \left\{\begin{matrix}1 - {\left(\frac{{\text{P}}_{0}}{{\text{P}}_{1}}\right)}^{\text{leverage}} , {\text{P}}_{1} > {\text{P}}_{0} \\ 1 - {\left(\frac{{\text{P}}_{1}}{{\text{P}}_{0}}\right)}^{\text{leverage}} , {\text{P}}_{1} < {\text{P}}_{0}\end{matrix}\right)$$

where P is the price of the underlying asset over time.

Preferably, the transfer function is further defined according to a rebalancing rate, which is defined by a difference in token value in the first and second pools.

Preferably, the smart contract allows for contract tokens to be minted (and burnt) when pool tokens are deposited (and removed) from the token pool.

In another form, the invention resides broadly in a blockchain method including:
receiving data from an oracle feed, defined on a blockchain, the oracle feed representing an off-chain data feed;
defining first and second token pools on the blockchain, each token pool including at least one pool token;
defining a smart contract by code on the blockchain, the smart contract configured to autonomously transfer pool tokens between the first and second pools according to data of the oracle feed; and
defining first and second contract tokens on the blockchain, each contract token associated with the smart contract and the first and second token pools.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Various embodiments of the invention will be described with reference to the following drawings, in which:

FIG. 1 illustrates a simplified schematic of a blockchain system, according to an embodiment of the present invention.

FIG. 2 illustrates a simplified schematic of an example illustrating a perpetual swap of the system of FIG. 1, according to an embodiment of the present invention.

FIG. 3 illustrates an example of a relationship between the fair price (dashed black line) and the mark price (solid black line) in the perpetual swap of FIG. 2.

FIG. 4 illustrates a simplified schematic of an example illustrating a perpetual pool of the system of FIG. 1, according to an embodiment of the present invention.

FIG. 5 is a graph comparing value transfer for linear leverage, and value transfer for according to a value transfer function of the perpetual pool of FIG. 4.

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way.

### DESCRIPTION OF EMBODIMENTS

Embodiments of the present invention provide various blockchain methods and systems, which are described below, which have particularly utility in relation decentralised finance applications.

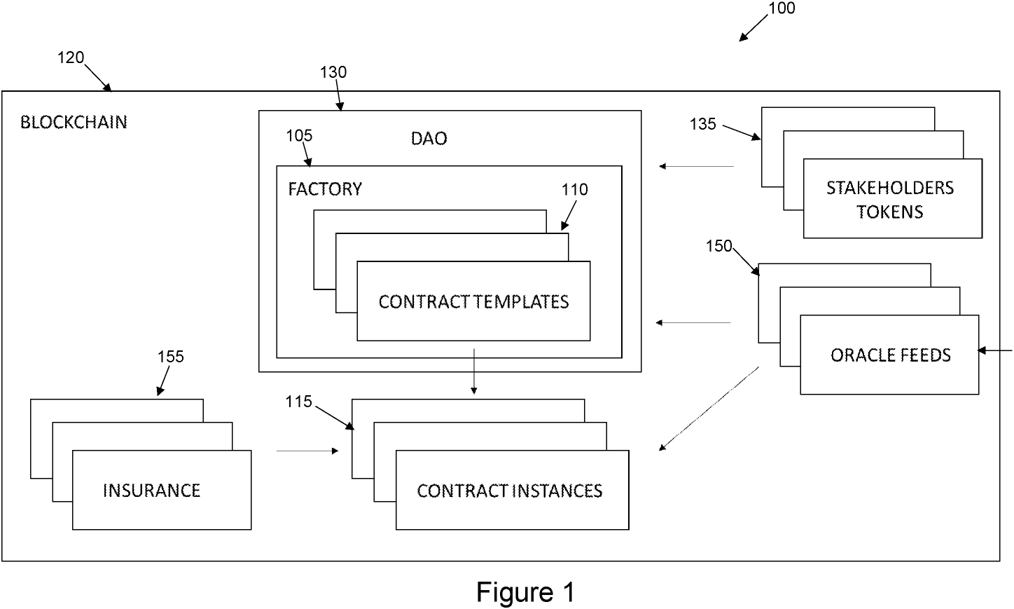

FIG. 1 illustrates a simplified schematic of a blockchain system 100, according to an embodiment of the present invention. Advantageously, the blockchain system 100 enables smart contract code templates to be used to generate instances of smart contracts, which lowers the cost of participating in financial markets, using blockchain technology to enforce property rights and settle financial contracts without the need for a trusted third party. This reduces the reliance on and risks associated with use of a trusted third party, such as unexpected downtime.

The blockchain system 100 further includes the ability to provide leveraged financial products that have more efficient liquidation mechanisms, or avoid liquidation altogether.

The blockchain system 100 includes a factory 105, which includes a plurality of smart contract templates 110. The smart contract templates 110 are configured to be deployed to create specific instances of smart contracts 115 (also referred to as markets) on a blockchain 120. The plurality of smart contract templates 110 may together define an ecosystem of standardised financial contracts, which may be used to create a variety of different types of smart contracts between users or groups of users in a tokenised manner, as outlined in further detail below.

The system 100 further includes a decentralized autonomous organization (DAO) 130, represented by rules encoded as code in the blockchain 120, which govern the factory 105 and can add to or modify the plurality of smart contract templates 110. This is achieved using stakeholder tokens 135 and a participation agreement in the form of a smart contract, stored on the blockchain 120, which grant rights to associated stakeholders according to the rules of the DAO, such as voting rights, as defined in the associated smart contract.

The contract templates 110 comprise code stored in the blockchain 120, and are transparent and viewable. In particular, once a smart contract template 110 has been installed into the factory 105, the terms and conditions specified within the code of the template 110 are viewable and transparent from the blockchain.

This enables users to view the contract templates 110, and for trust to be built around the contract templates 110. In short, users of the system (or anyone for that matter) can view the rules (terms) of the smart contracts 115 (and associated contract templates 110) in which they deal, and the review of smart contracts 115 may be simplified when based upon a known template 110.

To enable the smart contracts 115 to function based upon external input, the system 100 includes oracle feeds 150, which enable the smart contracts 115 to utilise external data and interact with systems outside of the blockchain 120. As an illustrative example, the price of gold may be provided by an oracle feed 150, which can be used by a smart contract 115 relating to gold futures, which require the changing price of gold as input. The skilled addressee will, however, readily appreciate that any suitable input, or combination of inputs, may be used, including price feeds and real-world data feed, or even inputs relating to calculations that are infeasible on the blockchain, and dispute resolution inputs.

An example of a smart contract for which the system is particularly useful is a perpetual swap contract. A perpetual swap is an agreement that allows two parties to go long and short on any underlying asset, for any amount of time.

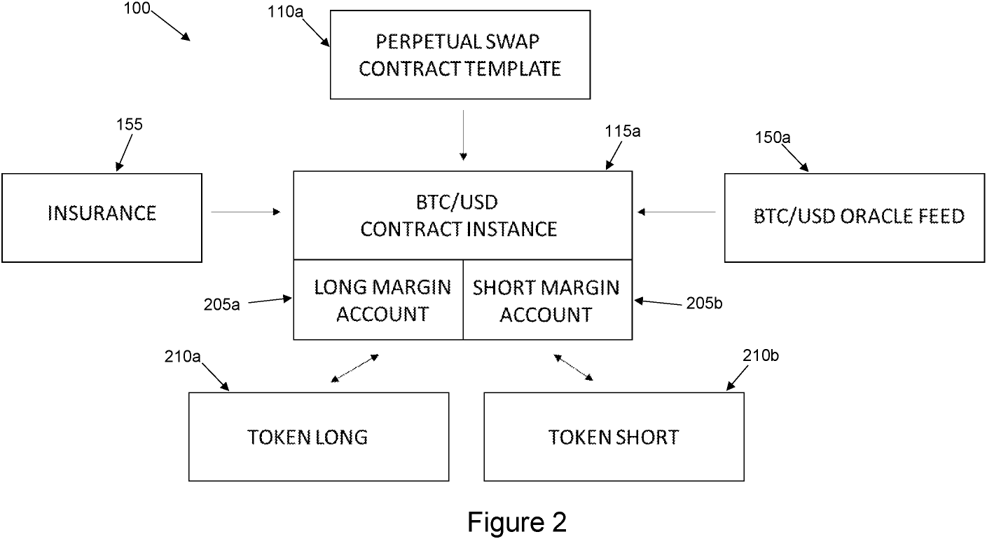

FIG. 2 illustrates a simplified schematic of an example illustrating a perpetual swap of the system 100, according to an embodiment of the present invention.

The system 100 includes a perpetual swap template 110a, which enables anyone to deploy a smart contract relating to a perpetual swap of any feasible market pair. A user may deploy a contract 115 using the perpetual swap smart contract template 110a by configuring the smart template according to a number of parameters, such as price feed, base asset and leverage multiplier. The base asset (that clears and settles the agreement) can be any ERC20 token (e.g. USDC) and the quote asset can be any derivative with an accessible price feed (e.g. BTC/USDC).

The example of FIG. 2 includes a Bitcoin / USD Coin (BTC/USDC) perpetual swap contract 115a, which receives the BTC/USDC price from a BTC/USDC oracle feed 150a. Each parties’ position with reference to the smart contract 115a is associated with a transferable token 210a, 210b, which can be traded on secondary markets.

This perpetual nature of the smart contract is permitted by the transfer of funds between parties of the smart contract 115a over time (the funding rate). The funding rate is a small fee that is paid between counter-parties to balance demand for the derivative position, ensuring that it tends towards the spot price for the underlying market.

To achieve this, each side (e.g. long/short) of the contract includes an associated margin account 205a, 205b, to which collateral is deposited in the base asset (e.g. USDC). Each margin account 205a, 205b is associated with the contract 115a only, and different margin accounts are used for each contract 115 (position). In other embodiments, however, a single margin account may be used for more than one contract 115 (position).

A monetary transfer is periodically made between the margin accounts 205a, 205b according to the funding rate, as defined by the contract, which ensures that the perpetual swap derivative accurately simulates the experience of holding the base asset (e.g. BTC or USDC). In the case where the funding rate is positive, it means that the transfer is from the long account 205a to the short account 205b, and conversely, when the funding rate is negative, it means that the transfer is from the short account 205b to the long account 205a.

The size of the position associated with of the token 210a, 210b is known as notional value and the profits/loss can be calculated as the notional value multiplied by the percentage difference between the current market price and the initial market price. In some embodiments, the change in value of a trader’s account following a movement in the price of the asset they hold is given by:

$$\begin{matrix}\text{Long-Value-change} \left(\text{t}\right) = \\ \text{National Value} \left(\text{t} - 1\right) ⋅ \frac{\text{Price} \left(\text{t}\right) - \text{Price} \left(\text{t} - 1\right)}{\text{Price} \left(\text{t} - 1\right)}\end{matrix}$$

$$\begin{matrix}\text{Short-Value-change} \left(\text{t}\right) = \\ \text{Notional Value} \left(\text{t} - 1\right) ⋅ \frac{\text{Price} \left(\text{t} - 1\right) - \text{Price} \left(\text{t}\right)}{\text{Price} \left(\text{t} - 1\right)}\end{matrix}$$

As the funding rate is defined by the contract 115a, such transfer happens on the blockchain 120 without requiring any manual transfer between parties associated with the long and short positions, or any trust between the parties. The funding is continuously paid, with the rate of payment changing once every 8 hours (i.e. it is quoted as an 8 hour rate and recalculated every 8 hours).

The funding rate is defined by a function of the difference between the value of the derivative position and the value of the oracle feed price (the premium). As an illustrative example, if the derivative position (as defined by the smart contract) is trading at $110 and the spot market is trading at $100, this indicates a higher demand for long exposure than for short exposure. A fee based upon this difference of $10 (the premium), is paid from long account 205a to the short account 205b, to drive the price down.

In one embodiment, the funding rate is defined by the following function:

$$\text{Funding rate = Premium x Sensitivity} \text{.}$$

Here, Premium (%) is the time-weighted difference between 1) the mark price of the derivative position and 2) the index price (the price provided by the oracle) adjusted by a time-value component (e.g. the average premium over the last 3 months), referred to as the fair price.

The time-weighted difference is computed by calculating the sum of each individual hour (for the last 8 hours), then multiplying it by (8 - t), where t is the time difference (in hours) between time and the current time.

Sensitivity is a multiplying factor applied to Premium. The sensitivity of the funding rate is best designed so that it is low when the derivative price is historically volatile; indicating a volatile underlying asset and/or low derivative liquidity. The default sensitivity is determined by the classification of the market, and in one embodiment is provided by the following:

| Market | Sensitivity |
|---|---|
| Cryptocurrency | 0.1 |
| Stock | 0.5 |
| Forex & Stablecoin | 3 |

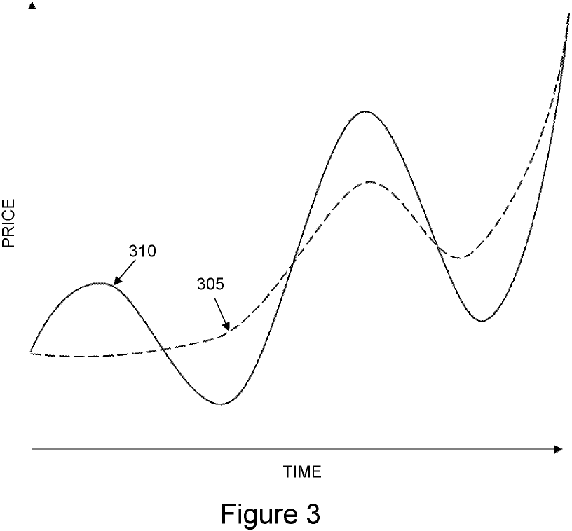

FIG. 3 illustrates an example of a relationship between the fair price 305 (dashed black line) and the mark price 310 (solid black line).

As the fair price 305 is time-weighted, it functions much like a low pass filter, removing peaks and troughs.

When the mark price 310 is greater than the fair price 305, the premium is positive and thus the funding rate positive. In contrast, when the mark price 310 is less than the fair price 305, the premium is negative and thus funding rate negative.

The use of the margin accounts 205a, 205b further allows leveraged perpetual swap contracts 115. Leverage is traditionally a trading mechanism which allows a trader to finance their investment through a combination of borrowed funds (debt) and margin. In the system 100, the same effect as leverage may be provided without borrowed funds, through use of the margin accounts 205a, 205b.

In such case, the margin accounts 205a, 205b must be kept at a certain level, to cover potential liquidation (referred to as the maintenance margin). In short, the maintenance margin is required to ensure that the likelihood of default is minimised, where the counterparty is unable to pay the counterparty.

An improved form of liquidation is then used when an account goes below its maintenance margin, in which a position (i.e. the token 210a, 210b) is repossessed by a trader or agent that has adequate margin.

In short, tokens 210a, 210b associated with positions below their maintenance margin can be acquired by anyone at a discount equal to the amount the position is below maintenance margin. If this discount is greater than the gas cost of liquidation, the token 210a, 210b can be purchased for a profit. To ensure the ability to fund this discount, the trader’s remaining margin (i.e. from the margin account 205a, 205b) is placed in margin escrow to cover liquidation costs (the discount, and any slippage costs).

The margin escrow account ensures the trader does not exit the position prior to compensating the liquidator. If the margin in the escrow account is insufficient to pay this discount amount, and insurance fund will instantly cover the amount.

In some embodiments, the maintenance margin is calculated as follows:

$$\begin{matrix}\text{Maintenance margin} = \frac{\text{Notional value}}{\text{Maximum leverage}} + \\ 6 ⋅ \left(\text{Liquidation gas cost}\right)\end{matrix}$$

The first component of the maintenance margin calculation (notional value/maximum leverage) considers potential order-book slippage and is deemed a sufficient buffer amount. The second component, 6 × liquidation gas cost of the last position, is included to partially protect the insurance fund from gas cost increases.

After the liquidator has purchased the token 205a, 205b, they can do one of two things. The liquidator can now either hold the token 205a, 205b or sell it back to the market. In the case where they sell it back to the market, there is a risk that the entire position cannot be sold at the market price due to insufficient market liquidity. This is known as slippage, or market liquidity risk.

If this occurs to a liquidator during the allowed time to claim slippage reimbursement (≈10 minutes), liquidators are guaranteed by the smart contract 115a to be reimbursed for any losses they incur, with the exception of gas cost, from the time they acquire a below-margin position to the time they sell it by an insurance pool 155.

In such case, liquidators are first paid an initial amount equal to the amount a position was below its maintenance margin. If they sell the position within 10 minutes, they also receive an additional amount equal to the losses from briefly holding and selling the position. These payments to the liquidator first come out of the trader’s remaining margin stored in margin escrow, and if this is exhausted, then from the insurance pool 155. If there is any margin remaining in escrow after this process it is returned to the trader (i.e. to the associated account 205a, 205b).

As such, the contract defines a riskless liquidation mechanism (for liquidators) via a slippage reimbursement receipt, rendering the act of liquidation risk-free and the cost to liquidated traders competitively inexpensive.

Virtually all prior art liquidation mechanisms charge traders a significant fixed portion or the entirety of a trader’s remaining margin. Fixed fees for liquidation cause high leverage positions to be prohibitively expensive. By enabling competitively inexpensive liquidation fees, the perpetual swap contract enables traders to take on high levels of leverage with reasonable margin requirements.

The slippage reimbursement receipt mechanism allows the insurance fund to cover slippage costs in excess of the remaining trader margin in escrow. In effect, the risk that a liquidator may lose money as a result of liquidating a position is eliminated. The only cost incurred by the liquidator during any liquidation transaction is the current gas price. Riskless liquidation encourages positions below their maintenance margin by any amount more than the current fast gas price to be liquidated as these positions represent risk-free profit.

Scenarios where the insurance pool 155 covers liquidation expenses generally occur when a small position is liquidated after a huge spike in the gas cost, or when the slippage on a large position is greater than the maintenance margin. The amount that the insurance pool 155 has to cover in both of these cases is often small, especially in markets with low volatility. As a result of mitigated insurance expenses, the insurance funding rate charged to leveraged traders is low. Low insurance funding fees and inexpensive competitive liquidation combine to let traders take greater leverage with lower minimum investment size.

In some embodiments, each perpetual swap market created by the smart contract template 115 has an isolated insurance pool 155 specific to that market allowing for liquidation risk to be localised.

The insurance pool 155 functions through depositors depositing collateral (e.g. USDC) and receive a token in exchange for their deposits which functions as a tradable fungible claim to their insurance position. The depositors then receive an insurance funding rate for that is paid by traders that leverage their position. The more a trader is leveraged, the higher their insurance funding rate payments.

The role of the insurance pool 155 is to effectively underwrite liquidators, to ensure that they can profitably liquidate positions that are nearing bankruptcy.

Users can either interact in an entirely peer-to-peer fashion though an order-book mechanism or in a peer-to-contract fashion through an Automated Market Maker (AMM), described in further detail below. When trading through an order-book, a trader can either take an order or make an order. Taking an order is choosing to match with an order that is already placed and publicly broadcast. Making an order is publicly broadcasting your order at a fixed quantity and price, waiting for it to be taken by another trader.

Once two counter-orders have been matched the agreement is considered live. An agent that wants to exit their position can sell it to another trader or to an AMM. Selling a position transfers the position to another party without cancelling the original agreement. The counterparty to the original agreement remains in a perpetual position regardless of position transfers. A trader taking a large position can also be matched with multiple counterparties who can then trade in and out of the position.

As outlined above, traders can interact through an AMM, which is an on-chain peer-to-contract mechanism. Perpetual swap AMMs buy and sell a derivative to traders at a price determined by a fixed pricing equation (otherwise called a bonding curve). AMMs act as standalone traders within a market and compete with one another by varying their on-chain fee rates.

Each contract instance has the ability to host an AMM, or multiple AMMs. While any AMM is compatible with the contract, agents may only deploy AMMs approved by the Factory. The addition of a new AMM pricing function requires a proposal to the DAO, upon which it may be accepted or ‘whitelisted’ for deployment.

AMMs within the perpetual swap system work the same as a margin account 205a, 205b. The AMM uses the quote asset of the market as margin. For a given asset pairing, liquidity providers can deposit quote assets into the AMM in exchange for a share of the AMM pool’s returns. This deposit increases the AMM’s quote holdings, and correspondingly, the overall number of pool tokens (these are proportional to one another - e.g. 1% more quote mints 1% more pool tokens). Pool tokens are sent to the liquidity provider that deposited. The AMM’s fees grow the pool holdings over time (more quote), increasing the value of existing pool tokens. Returns can be realised when the liquidity provider burns pool tokens in exchange for their share of the quote token holdings.

Another example of a smart contract for which the system is particularly useful is a perpetual pool contract. A perpetual pool is similar to a perpetual swap, in that it is an agreement that allows parties to go long and short on any underlying asset, for any amount of time, but utilises pools 405a, 405b of collateral associated with multiple tokens 410a, 410b, where collateral is moved between long and short sides of the pool in response to a changing price feed. As collateral is moved between the long and short sides, the amount of collateral per token (share) of the pool changes.

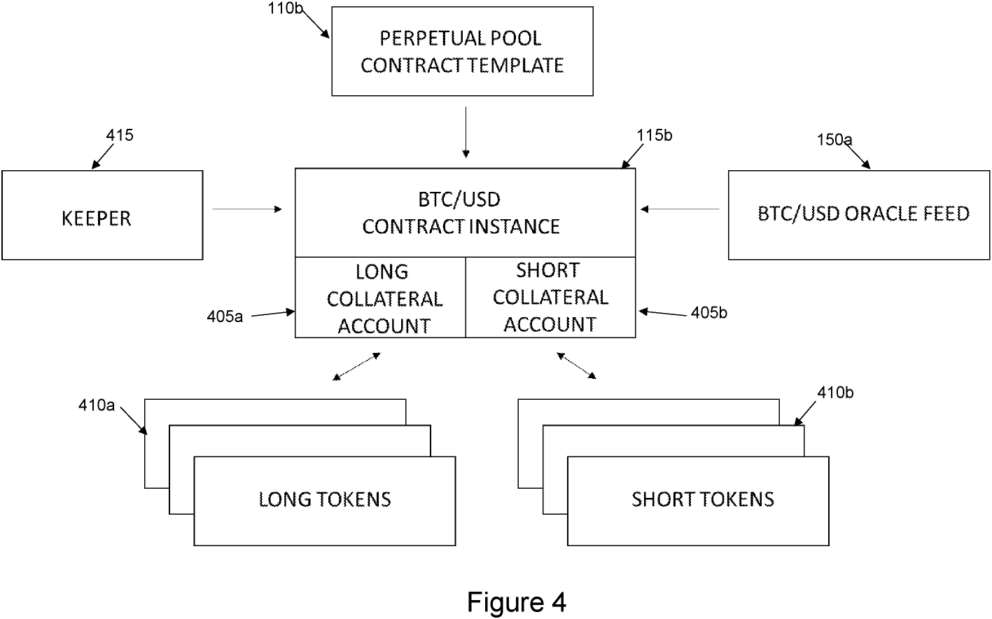

FIG. 4 illustrates a simplified schematic of an example illustrating a perpetual pool of the system 100, according to an embodiment of the present invention.

The system includes a perpetual pool template 110b, which enables anyone to deploy a smart contract relating to a perpetual pool of any feasible market pair. A user may deploy a contract 115 using the perpetual pool smart contract template 110a by configuring the smart template according to a number of parameters, such as price feed, base asset and leverage multiplier. Similar to the perpetual swap outlined above, the base asset (that clears and settles the agreement) can be any ERC20 token (e.g. USDC) and the quote asset can be any derivative with an accessible price feed (e.g. BTC/USD).

The example of FIG. 4 includes a Bitcoin / USD Coin (BTC/USDC) perpetual pool contract 115b, which receives the BTC/USDC price from the BTC/USDC oracle feed 150a.

This perpetual nature of the perpetual pool is permitted by long and short users, through the tokens 410a, 410b, that have changing claims on a pool of collateral. To achieve this, each side (e.g. long/short) of the contract includes an associated collateral account pool 405a, 405b, to which collateral is deposited in the base asset (e.g. USDC) for the entire pool.

When traders commit collateral to an associated collateral account 205a, 205b, corresponding tokens 410a, 410b are minted, which represents their claim on the collateral in the pool 405a, 405b. Shares of the long side are called L-tokens 410a and shares of the short side are called S-tokens 410b. In short, users can mint new tokens 410a, 410b by adding collateral to an associated pool 405a, 405b, or burn existing tokens 410a, 410b to redeem collateral from the pool 405a, 405b according to their shareholding.

The value of the shares associated with the tokens 410a, 410b are determined by the proportion of collateral held in each side of the pool 405a, 405b, which updates periodically (at a rebalancing event) according to a transfer function. The transfer function, which is defined in the smart contract 115b, causes the transfer of pool tokens from one side to the other (i.e. from one collateral account 405a, 405b to the other 405a, 405b) when a pre-defined condition has been met (e.g. time period, price change (%), momentum threshold). The amount, and direction, of the transfer is calculated using the transfer function, which accounts for values provided by a price feed.

While any suitable transfer function may be used, in one embodiment the transfer function is non-linear, but such that almost linear returns are provided for typical price movements (according to the chosen leverage), but for extreme price movements, returns are dampened, so users can never lose 100% of their collateral.

An example of a function that performed well in these circumstances is:

$$\text{Value Transfer} \left(\%\right) = \left\{\begin{matrix}1 - {\left(\frac{{\text{P}}_{0}}{{\text{P}}_{1}}\right)}^{\text{leverage}} , {\text{P}}_{1} > {\text{P}}_{0} \\ 1 - {\left(\frac{{\text{P}}_{1}}{{\text{P}}_{0}}\right)}^{\text{leverage}} , {\text{P}}_{1} < {\text{P}}_{0}\end{matrix}\right)$$

where P is the price of the underlying asset over time.

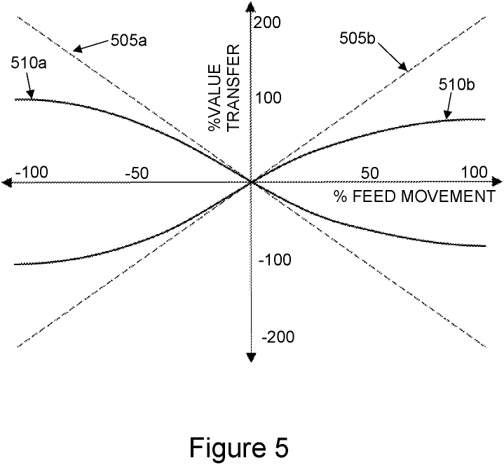

FIG. 5 is a graph comparing value transfer for linear leverage 505a, 505b, and value transfer for according to the above value transfer function 510a, 510b for 2× leverage.

As can be seen from the value transfer function 510a, 510b, value transfer tends towards 100 (and -100) for large changes in feed movement (e.g. close to 100% changes), while being close to linear for small changes (e.g. 5%). This prevents any side (i.e. pool 405a, 405b) from ever losing 100% or more of its collateral, and thus alleviates the need for liquidation and insurance.

The value transfer is calculated when a pool updates. A pool update moves collateral from one account pool 405a, 405b to the other 405a, 405b and adds any new collateral to the pool. It’s also when traders can redeem their collateral and fees are taken.

An update is also called the rebalancing event because it serves to rebalance the collateral between long and short sides in the correct proportion. In some embodiments, the rebalancing event happens every hour, but any suitable event may be used, including a percent price change (or any arbitrary condition for that matter).

In the case where long and short collateral pools 405a, 405b are at parity, an x% transfer from one side will equate to an x% gain for the other side. However, in the case where long and short collateral pools 405a, 405b are not equal, an x% transfer from one side will not result in an x% gain for the other side.

Instead, the side’s gain is adjusted by the rebalancing rate. A favourable rebalancing rate presents asymmetric upside for the less collateralised side. The formula describing rebalancing rate follows:

$$\text{Rebalancing Rate} \left(\%\right) = \left(\frac{\text{Long Collateral}}{\text{Short Collateral}}\right) - 1$$

The rebalancing rate will typically tend towards 0%, as an asymmetric upside will naturally attract collateral inflow, causing a return to parity. The function below can be used to calculate a side’s gain:

$$\begin{matrix}\text{Gain} \left(\%\right) = \\ \left\{\begin{matrix}\left(\frac{1}{1 + \text{Rebalancing Rate} \left(\%\right)}\right) \times \text{Value Transfer} \left(\%\right) , \text{Long} \\ \left(1 + \text{Rebalancing Rate} \left(\%\right)\right) \times \text{Value Transfer} \left(\%\right) , \text{Short}\end{matrix}\right)\end{matrix}$$

As outlined above, the proportion of collateral held in each side of the pool 405a, 405b updates periodically (at a rebalancing event) according to the transfer function. In particular, traders queue to mint and burn tokens with a pool (to add collateral or remove collateral), and once they have placed an order, they cannot leave the queue.

The rate traders get for tokens is determined by the value transfer. The pools 405a, 405b fill queued mint and burn orders so that the post-rebalance proportion of tokens 410a, 410b to collateral stays constant. For new pools, this proportion is 1:1.

Users can commit to mint (burn) tokens 410a, 410b to (from) the pool 405a, 405b at the upcoming value transfer. A keeper 415 executes the value transfer, which updates the proportion of collateral held in each side of the pool 405a, 405b and mints (burns) tokens 410a, 410b. The percentage transferred is calculated by the transfer function, using the underlying price feed (given by the oracle feed 150a). Collateral is then moved from the short side 405b to the long side 405a in the case of price appreciation or from the long 405a to the short 405b in the case of price depreciation.

The minting (burning) activity does not change the price of the existing tokens 410a, 410b, but allows for users to add (remove) collateral to (from) a pool 405a, 405b. New tokens 410a, 410b are created so that the ratio of pool tokens to collateral remains constant or, if there is no existing collateral of the type deposited, at a 1:1 ratio.

As outlined above, because the new price for the value transfer, pools employ the keeper 415 to tell them when it’s time to fetch the price, transfer collateral, and mint/burn pool tokens 410a, 410b. In reality, the keeper is a bot that automates the rebalancing event for a fee.

In use, traders deposit (and request withdrawal of) collateral from the respective long and short collateral accounts (pools) 405a, 405b. As outlined above, this may be done up to a predefined time prior to a rebalance event.

When the keeper 415 determines a rebalance event, it initially determines collateral balances in the respective pools 405a, 405b, pulls the price feed from the oracle feed 150a, and determines rebalance calculations, as outlined above.

A transfer of value between the pools 405a, 405b is then made according to the transfer function.

After the transfer, tokens 410a, 410b are minted and burned, for the new rebalance period. In the case tokens 410a, 410b are burned, a portion of pool tokens (i.e. collateral) in the corresponding pool 405a, 405b is returned.

The process is then repeated in perpetuity.

While the above examples have related to financial products, and in particular derivative products, namely long and short positions relating to a particular underlying financial asset, the skilled addressee will readily appreciate that the systems and methods have broader application, and may function based upon any suitable type of input.

As an illustrative example, the oracle feed may provide non-financial data as input, such as weather data, and the actions performed by the transfer of tokens may be non-financial.

Each smart contract template 110 may include remuneration terms for its creator or modifier. Dynamic incentive packages can be structured around financial contract transaction fees, market usage or other quantifiable metrics. This may be useful in motivate contribution or collaboration.

The system 100 may be configured such that any updates to contract templates 110 are only used in relation to new contract instances and not existing contract instances. As such, the system is able to be updated and improved over time, without effecting existing instances of the contracts.

To protect the system 100 against oracle 150 failure, the smart contracts can be engineered to mitigate the damage caused by oracle failure. If there is an error with the oracle input 150 that is detected on-chain, the smart contracts may autonomously failover to another oracle solution.

Advantageously, the systems and methods disclosed herein provide various benefits over the prior art. The blockchain system 100 enables smart contract code templates to be used to generate instances of smart contracts, which lowers the cost of participating in financial markets, using blockchain technology to enforce property rights and settle financial contracts without the need for a trusted third party.

This reduces the reliance on, and risks associated with, use of a trusted third party, such as unexpected downtime. In short, the systems and methods leverage blockchain to provide censorship-resistant market connectivity, as once a financial contract has been deployed it may function in an entirely permissionless manner.

The blockchain system 100 further includes the ability to provide leveraged financial products that have more efficient liquidation mechanisms, or avoid liquidation altogether.

In the case of perpetual swaps, a Dutch auction type liquidation is provided, where liquidators are insured against slippage using a low cost insurance mechanism. This in turn enables users can trade at higher leverage and open positions with small investment sizes.

In the case of perpetual pools, liquidation is avoided altogether.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A blockchain system including:
an oracle feed, defined on a blockchain, the oracle feed representing an off-chain data feed;
first and second token pools defined on the blockchain, each token pool including at least one pool token;
a smart contract defined by code on the blockchain, the smart contract configured to autonomously transfer pool tokens between the first and second pools according to data of the oracle feed; and
first and second contract tokens defined on the blockchain, each contract token associated with the smart contract and the first and second token pools.

2. The blockchain system of claim 1, further including one or more smart contract templates defined in the blockchain, wherein the smart contract comprises an instance of a smart contract template of the one or more smart contract templates.

3. The blockchain system of claim 1, wherein the oracle feed corresponds to a price feed, wherein the smart contract corresponds to a financial derivative associated with the price feed.

4. The blockchain system of claim 1, wherein the transfer of pool tokens between the first and second pools is according to a transfer function defined by the smart contract and according to the oracle feed.

5. The blockchain system of claim 1, wherein the smart contract comprises a perpetual swap smart contract.

6. The blockchain system of claim 5, wherein the system includes a perpetual swap smart contract template on what the perpetual swap contract is based, wherein the perpetual swap smart contract template is configured to use an oracle price feed and a base asset to define the perpetual swap smart contract.

7. The blockchain system of claim 5, wherein the smart contract is configured to enable the autonomous transfer of contract tokens when a size of the associated token pool is below a threshold.

8. The blockchain system of claim 5, wherein the transfer of pool tokens between the first and second pools is according to a transfer function defined by the smart contract and according to the oracle feed, and wherein the transfer function is defined at least in part according to a time-weighted difference between 1) a mark price of the derivative position defined by the contract tokens and 2) an index price provided by the oracle feed adjusted by a time-value component.

9. The blockchain system of claim 8, wherein the time-value component comprises a weighted average of the index price over time, where recent index prices have a higher weight than older index prices.

10. The blockchain system of claim 5, wherein the threshold comprises a function of a notional value of the corresponding contract token, leverage, and the cost required to perform a transaction on the blockchain.

11. The blockchain system of claim 5, wherein the smart contract is configured to calculate a difference between a value of the transfer of the contract tokens and the subsequent value of a subsequent transfer of the contract tokens, and transfer pool tokens according to a difference between the value and subsequent value when the subsequent transfer of the contract tokens is within a defined period of time from the transfer of the contract tokens.

12. The blockchain system of claim 1, wherein the smart contract comprises a perpetual pool smart contract.

13. The blockchain system of claim 12, wherein the first and second token pools each include a plurality of pool tokens.

14. The blockchain system of claim 12, wherein the transfer of pool tokens between the first and second pools occurs upon a pre-defined condition being met, preferably a predefined time period.

15. The blockchain system of claim 12, wherein the transfer function is non-linear.

16. The blockchain system of claim 15, wherein the transfer function is configured to transfer less than 100% regardless of a change in the oracle feed and leverage used.

17. The blockchain system of claim 16, wherein the transfer function is configured to provide near linear returns for small price movements (according to the leverage), and dampened returns for large price movements.

18. The blockchain system of claim 12, wherein the transfer function is further defined according to a rebalancing rate, which is defined by a difference in token value in the first and second pools.

19. The blockchain system of claim 12, wherein the smart contract allows for contract tokens to be minted and burnt when pool tokens are deposited (and removed) from the token pool.

20. A blockchain method including:
receiving data from an oracle feed, defined on a blockchain, the oracle feed representing an off-chain data feed;
defining first and second token pools on the blockchain, each token pool including at least one pool token;
defining a smart contract by code on the blockchain, the smart contract configured to autonomously transfer pool tokens between the first and second pools according to data of the oracle feed; and
defining first and second contract tokens on the blockchain, each contract token associated with the smart contract and the first and second token pools.
